(19) United States
(12) Patent Application Publication
(10) Pub. No.: US 2018/0365989 A1
(43) Pub. Date: Dec. 20, 2018

(54) SYSTEM AND METHOD FOR WRONG-WAY DRIVING DETECTION AND MITIGATION

(71) Applicant: GM Global Technology Operations LLC, Detroit, MI (US)

(72) Inventors: Xiaofeng F. SONG, Novi, MI (US); Valor YALDO, West Bloomfield, MI (US)

(21) Appl. No.: 15/628,139

(22) Filed: Jun. 20, 2017

(51) Int. Cl. G08G 1/056; B60W 50/16; B60W 30/085; G01C 21/36

(52) U.S. Cl. CPC G08G 1/056; G01C 21/3697; B60W 30/085; B60W 50/16

(57) ABSTRACT

A wrong-way determination system is disclosed. The wrong-way determination system includes a wrong-way determination module that is configured to determine a vehicle is traveling in a wrong direction when a current position of the vehicle with respect to a shape point does not exceed a width of a roadway and a deviation between a heading angle of the vehicle and a heading angle of the roadway exceeds a predetermined threshold. The wrong-way determination system also includes a mitigation module that is configured to generate a mitigation signal when the vehicle is traveling in the wrong direction.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to systems and methods for vehicle wrong-way detection. More particularly, the system and method uses data indicative of an environment around a vehicle captured by one or more sensors to determine whether the vehicle is traveling in the wrong direction.

Vehicles can employ sensors that detect information regarding an environment in which the vehicle operates. These sensors can include image capture devices, such as cameras, radar, light detection and ranging (LIDAR), ultrasonic, and the like. Various vehicle systems can utilize this information to assist the operator of the vehicle in navigating the environment.

### SUMMARY

In an example, a wrong-way determination system is disclosed. The wrong-way determination system includes a wrong-way determination module that is configured to determine a vehicle is traveling in a wrong direction when a current position of the vehicle with respect to a shape point does not exceed a width of a roadway and a deviation between a heading angle of the vehicle and a heading angle of the roadway exceeds a predetermined threshold. The wrong-way determination system also includes a mitigation module that is configured to generate a mitigation signal when the vehicle is traveling in the wrong direction.

In other features, the roadway includes a roadway marker and the shape point corresponds to the roadway marker. In other features, the shape point includes a latitude coordinate, a longitude coordinate, a heading angle, a road width, an altitude, and a roadway lane curvature. In other features, the wrong-way determination module determines a distance between the current position and the shape point and compares the distance to the width of the roadway.

In other features, the wrong-way determination module determines the distance according to |p_{g,t}−p_{m,k}| sin θ; θ=αₚ_{_{g,t}}_{,p}_{_{m,k}}−αₚ_{_{m,k}}, where p_{g,t} represents the current position, p_{m,k} represents a nearest shape point, αₚ_{_{g,t}}_{,p}_{_{m,k}} represents arctan((Lat_{g,t}−Lat_{m,k})/(Lon_{g,t}−Lon_{m,k})), where Lat_{g,t} represents a latitude coordinate of the vehicle at the current position, where Lat_{m,k} represents latitude coordinate of the nearest shape point, where Lon_{g,t} represents a longitude coordinate of the vehicle at the current position, where Lon_{m,k} represents a longitude coordinate of the nearest shape point, and αₚ_{_{m,k}} represents a heading angle of the roadway at the shape point.

In other features, the wrong-way determination module determines the distance according to

$$\frac{\vert ( {lat}_{m , k + 1} - {lat}_{m , k} ) {lon}_{g , t} - ( {lon}_{m , k + 1} - {lon}_{m , k} ) {lat}_{g , t} + {lon}_{m , k + 1} {lat}_{m , k} - {lat}_{m , k + 1} {lon}_{m , k} \vert}{{[ {( {lat}_{m , k + 1} - {lat}_{m , k} )}^{2} + {( {lon}_{m , k + 1} {lon}_{m , k} )}^{2} ]}^{\frac{1}{2}}} ,$$

where lat_{m,k+1} represents a latitude coordinate of the roadway at a next shape point, lat_{m,k} represents a latitude coordinate of the roadway at the shape point, lon_{g,t} represents a longitude coordinate of the current position, lon_{m,k+1} represents a longitude coordinate of the roadway at the next shape point, lon_{m,k} represents a longitude coordinate of the roadway at the shape point.

In other features, the mitigation signal causes a driver warning device to notify a driver of the vehicle that the vehicle is traveling in the wrong direction. In other features, the driver warning device displays a notification, generates haptic feedback, generates external feedback, or generates a sound. In other features, the wrong-way determination system includes a lane curvature determination module that is configured to determine a vehicle lane curvature variable, and the wrong-way determination module is further configured to determine the vehicle is traveling in the wrong direction when a deviation between the vehicle lane curvature variable and a roadway lane curvature variable exceeds a predetermined threshold.

In other features, the wrong-way determination module determines whether the deviation exceeds the predetermined threshold according to (|κₚ_{_{m,k,LS}}+κₚ_{_{m,k,MAP}}|<Low_Threshold && |κₚ_{_{m,k,LS}}−κₚ_{_{m,k,MAP}}|>High_Threshold), where κₚ_{_{m,k,LS}} represents the vehicle lane curvature variable and κₚ_{_{m,k,MAP}} represents the roadway lane curvature variable.

In other features, the mitigation module initiates a time counter, wherein the mitigation module generates a mitigation signal to control operation of the vehicle when the time period exceeds a predetermined time and no driver input has been received within the predetermined time.

In an example, a method includes determining that a vehicle is traveling in a wrong direction when a current position of the vehicle with respect to a shape point does not exceed a width of a roadway and a deviation between a heading angle of the vehicle and a heading angle of the roadway exceeds a predetermined threshold. The method also includes generating a mitigation signal when the vehicle is traveling in the wrong direction.

In other features, the method further includes causing a driver warning device to notify a driver of the vehicle that the vehicle is traveling in the wrong direction based upon the mitigation signal. In other features, the method further includes determining a vehicle lane curvature variable. The method also includes determining the vehicle is traveling in the wrong direction when a deviation between the vehicle lane curvature variable and a roadway lane curvature variable exceeds a predetermined threshold.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example wrong-way determination system according to the principles of the present disclosure;

FIG. 2 is a functional block diagram of an example wrong-way determination module according to the principles of the present disclosure;

FIGS. 3A and 3B are diagrammatic illustrations of vehicles traversing roadways, where the roadways have various shape point data elements that describe one or more roadway parameters according to the principles of the present disclosure;

FIG. 4 is a diagrammatic illustration of various angles with respect to a defined direction that are used to calculate a distance between a vehicle and a nearest shape point; and

FIG. 5 is a flowchart illustrating an example method for determining whether a vehicle is traveling in the wrong direction according to the principles of the present disclosure.

In the drawings, reference numbers may be reused to identify similar and identical elements.

### DETAILED DESCRIPTION

Wrong-way driving accidents occur when an operator (i.e., a driver) enters a roadway traveling in the wrong direction. Driving in the wrong direction can result in accidents involving the vehicle driven in the wrong direction and other vehicles, property, or the like.

In implementations, a wrong-way determination system according to the present disclosure includes a wrong-way determination module that determines that a vehicle is traveling in a wrong direction. The wrong-way determination module determines the vehicle is traveling in the wrong direction when a current position of the vehicle with respect to a shape point does not exceed a width of a roadway and a deviation between a heading angle of the vehicle and a heading angle of the roadway exceeds a predetermined threshold. The wrong-way determination system also includes a mitigation module that generates a mitigation signal when the vehicle is traveling in the wrong direction.

In some implementations, the wrong-way determination system includes lane curvature determination module that determines a vehicle lane curvature variable. The wrong-way determination module can determine that the vehicle is traveling in the wrong direction when a deviation between the vehicle lane curvature variable and a roadway lane curvature variable exceeds a predetermined threshold

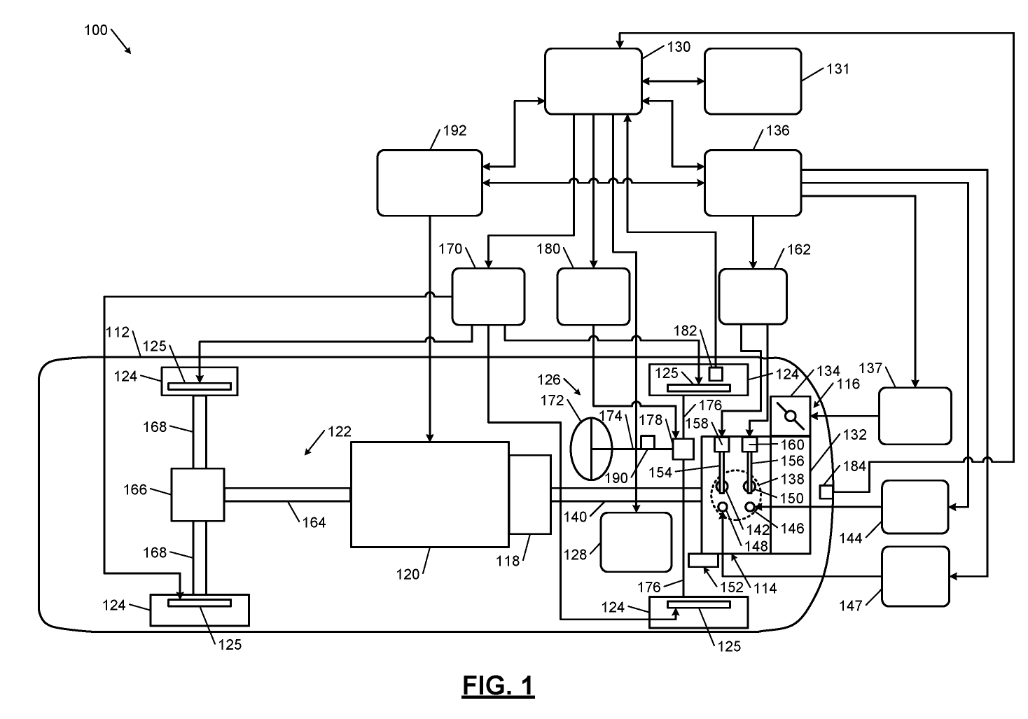

Referring to FIG. 1, a wrong-way determination system 100 includes a vehicle 110. The vehicle 110 includes a vehicle body 112, an engine 114, an intake system 116, a torque converter 118, a transmission 120, a driveline 122, wheels 124, friction brakes 125, a steering system 126, and a driver warning device 128. The engine 114 combusts an air/fuel mixture to produce drive torque for the vehicle 110. The amount of drive torque produced by the engine 114 is based on a driver input. A driver control module (DCM) identifies when the vehicle 110 is traveling in the wrong direction on a roadway.

A global positioning system (GPS) module 131 generates GPS signals identifying a location of the vehicle 110. The GPS module 131 may be onboard (e.g., part of) the vehicle 110 or the GPS module 131 may be remote from (e.g., separate from) the vehicle 110. The GPS module 131 includes a transceiver for communicating with a GPS satellite.

Air is drawn into the engine 114 through the intake system 116. The intake system 116 includes an intake manifold 132 and a throttle valve 134. The throttle valve 134 may include a butterfly valve having a rotatable blade. An engine control module (ECM) 136 controls a throttle actuator module 137, which regulates opening of the throttle valve 134 to control the amount of air drawn into the intake manifold 132.

Air from the intake manifold 132 is drawn into cylinders of the engine 114. While the engine 114 may include multiple cylinders, for illustration purposes a single representative cylinder 138 is shown. For example only, the engine 114 may include 2, 3, 4, 5, 6, 8, 10, and/or 12 cylinders. The ECM 136 may deactivate some of the cylinders, which may improve fuel economy under certain engine operating conditions.

The engine 114 may operate using a four-stroke cycle. The four strokes, described below, are named the intake stroke, the compression stroke, the combustion stroke, and the exhaust stroke. During each revolution of a crankshaft 140, two of the four strokes occur within the cylinder 138. Therefore, two crankshaft revolutions are necessary for the cylinder 138 to experience all four of the strokes.

During the intake stroke, air from the intake manifold 132 is drawn into the cylinder 138 through an intake valve 142. The ECM 136 controls a fuel actuator module 144, which regulates fuel injections performed by a fuel injector 146 to achieve a target air/fuel ratio. Fuel may be injected into the intake manifold 132 at a central location or at multiple locations, such as near the intake valve 142 of each of the cylinders. In various implementations, fuel may be injected directly into the cylinders or into mixing chambers associated with the cylinders. The fuel actuator module 144 may halt injection of fuel to cylinders that are deactivated.

The injected fuel mixes with air and creates an air/fuel mixture in the cylinder 138. During the compression stroke, a piston (not shown) within the cylinder 138 compresses the air/fuel mixture. The engine 114 may be a compression-ignition engine, in which case compression in the cylinder 138 ignites the air/fuel mixture. Alternatively, the engine 114 may be a spark-ignition engine, in which case a spark actuator module 147 energizes a spark plug 148 to generate a spark in the cylinder 138 based on a signal from the ECM 136, which ignites the air/fuel mixture. The timing of the spark may be specified relative to the time when the piston is at its topmost position, referred to as top dead center (TDC).

The spark actuator module 147 may be controlled by a spark timing signal specifying how far before or after TDC to generate the spark. Because piston position is directly related to crankshaft rotation, operation of the spark actuator module 147 may be synchronized with crankshaft angle. In various implementations, the spark actuator module 147 may halt provision of spark to deactivated cylinders.

Generating the spark may be referred to as a firing event. The spark actuator module 147 may have the ability to vary the timing of the spark for each firing event. The spark actuator module 147 may even be capable of varying the spark timing for a next firing event when the spark timing signal is changed between a last firing event and the next firing event. In various implementations, the engine 114 may include multiple cylinders and the spark actuator module 147 may vary the spark timing relative to TDC by the same amount for all cylinders in the engine 114.

During the combustion stroke, combustion of the air/fuel mixture drives the piston down, thereby driving the crankshaft 140. The combustion stroke may be defined as the time between the piston reaching TDC and the time at which the piston returns to bottom dead center (BDC). During the exhaust stroke, the piston begins moving up from BDC and expels the byproducts of combustion through an exhaust valve 150. The byproducts of combustion are exhausted from the vehicle via an exhaust system 152.

The intake valve 142 may be controlled by an intake camshaft 154, while the exhaust valve 150 may be controlled by an exhaust camshaft 156. In various implementations, multiple intake camshafts (including the intake camshaft 154) may control multiple intake valves (including the intake valve 142) for the cylinder 138 and/or may control the intake valves (including the intake valve 142) of multiple banks of cylinders (including the cylinder 138). Similarly, multiple exhaust camshafts (including the exhaust camshaft 156) may control multiple exhaust valves for the cylinder 138 and/or may control exhaust valves (including the exhaust valve 150) for multiple banks of cylinders (including the cylinder 138).

The time at which the intake valve 142 is opened may be varied with respect to piston TDC by an intake cam phaser 158. The time at which the exhaust valve 150 is opened may be varied with respect to piston TDC by an exhaust cam phaser 160. A valve actuator module 162 may control the intake and exhaust cam phasers 158, 160 based on signals from the ECM 136. When implemented, variable valve lift may also be controlled by the valve actuator module 162.

The valve actuator module 162 may deactivate the cylinder 138 by disabling opening of the intake valve 142 and/or the exhaust valve 150. The valve actuator module 162 may disable opening of the intake valve 142 by decoupling the intake valve 142 from the intake cam phaser 158. Similarly, the valve actuator module 162 may disable opening of the exhaust valve 150 by decoupling the exhaust valve 150 from the exhaust cam phaser 160. In various implementations, the valve actuator module 162 may control the intake valve 142 and/or the exhaust valve 150 using devices other than camshafts, such as electromagnetic or electrohydraulic actuators.

The ECM 136 adjusts the position of the throttle valve 134, the amount and/or timing of fuel injections performed by the fuel injector 146, the timing at which spark is generated by the spark plug 148, and/or the timing at which the intake and exhaust valves 142 and 150 are opened to achieve a target torque output of the engine 114. The ECM 136 determines the target engine torque based on the driver input.

Torque output at the crankshaft 140 is transferred through the torque converter 118, through the transmission 120, through the driveline 122, and to the wheels 124. The driveline 122 includes a drive shaft 164, a differential 166, and axle shafts 168. The torque converter 118, the transmission 120, and the differential 166 amplify engine torque by several gear ratios to provide axle torque at the axle shafts 168. The axle torque rotates the wheels 124, which causes the vehicle 110 to accelerate in a forward or rearward direction.

The friction brakes 125 are mounted to the wheels 124. The friction brakes 125 resist (slow) rotation of the wheels 124 when the friction brakes 125 are applied. The friction brakes 125 may include drum brakes and/or disc brakes, and may include electrohydraulic actuators and/or electromechanical actuators that press a brake pad against a brake disc and/or drum when the friction brakes 125 are applied. A brake actuator module 170 applies the friction brakes 125 based on a brake pedal position and/or a signal from the DCM 130. The friction brakes 125 may be independently applied at different levels.

The steering system 126 selectively turns the front wheels 124, thereby turning the vehicle 110. The steering system 126 includes a steering wheel 172, a steering column 174, one or more steering linkages 176, and a steering actuator 178. A driver may rotate the steering wheel 172 to turn the vehicle 110 left or right or to input a request to turn the vehicle 110 left or right. The steering column 174 is coupled to the steering wheel 172 so that the steering column 174 rotates when the steering wheel 172 is rotated. The steering column 174 may also be coupled to the steering linkages 176 so that rotation of the steering column 174 causes translation of the steering linkages 176. The steering linkages 176 are coupled to the front wheels 124 so that translation of the steering linkages 176 turns the wheels 124.

The steering actuator 178 is coupled to the steering linkages 176 and translates the steering linkages 176, thereby turning the front wheels 124. In various implementations, the steering actuator 178 may be an electrohydraulic and/or electromechanical actuator. In implementations where the steering column 174 is coupled to the steering linkages 176, such as power steering systems, the steering actuator 178 may reduce the amount of effort that the driver must exert to turn the vehicle 110 left or right. In various implementations, the steering column 174 may not be coupled to the steering linkages 176, and the steering actuator 178 alone may translate the steering linkages 176. Steering systems where the steering column 174 is not be coupled to the steering linkages 176 may be referred to as a steer-by-wire system.

A steering actuator module 180 adjusts actuation of the steering actuator 178 based on a signal from the DCM 130. The DCM 130 may control the steering actuator 178 based on the angular position of the steering wheel 172. Alternatively, the DCM 130 may control the steering actuator 178 autonomously (e.g., independent of the angular position of the steering wheel 172).

One or more wheel speed sensors 182 are mounted to one or more of the wheels 124 and measures the speed of wheels 124, respectively. For example, one wheel speed sensor may be provided for each wheel and measure that wheels wheel speed.

A forward facing camera 184 is mounted to capture images of in front of the vehicle body 112 and generates an image of the environment in front of the vehicle 110. The forward facing camera 184 may be located, for example, in a front fascia of the vehicle 110, as exemplified in FIG. 1. the forward facing camera 184, however, may be located elsewhere, such as with a rear view mirror inside of a front wind shield of the vehicle or at another suitable location to capture images of in front of the vehicle 110.

A steering wheel angle sensor 190 measures the angular position of the steering wheel 172 relative to a predetermined position. The predetermined position may correspond to a location where the vehicle should (or does) travel straight along a longitudinal axis of the vehicle. The steering wheel angle sensor 190 may be mounted to the steering column 174 and may include, for example, a Hall Effect sensor that measures the angular position of a shaft that is disposed within the steering column 174 and rotatably coupled to the steering wheel 172.

A transmission control module (TCM) 192 shifts gears of the transmission 120 based on operating conditions of the vehicle 110 and a predetermined shift schedule. The operating conditions may include the speed of the vehicle 110, a target acceleration of the vehicle 110, and/or a target torque output of the engine 114. The TCM 192 may determine a vehicle speed based on wheel speeds measured using the wheel speed sensors 182. For example, the TCM 192 may determine the vehicle speed based on an average of the wheel speeds or an average of speeds of undriven (i.e., non-driven) wheels of the vehicle. The TCM 192 may receive the target vehicle acceleration and/or the target engine torque from the DCM 130 and/or the ECM 136. The ECM 136 may communicate with the TCM 192 to coordinate shifting gears in the transmission 120. For example, the ECM 136 may reduce engine torque during a gear shift.

The DCM 130 may activate a driver warning device 128 to notify the driver that the vehicle 110 is traveling in the wrong direction. The driver warning device 128 may include an electronic display (e.g., a touchscreen display) that is within the view of the driver and is operable to display lights, text, and/or images. Additionally or alternatively, the driver warning device 128 may include a heads-up display (HUD) that, for example, projects light, text, and/or images onto a windshield (not shown) of the vehicle 110. Additionally or alternatively, the driver warning device 128 may include one or more vibrators mounted to, for example, the steering wheel 172 and/or the driver's seat (not shown) to provide haptic feedback to the driver. Additionally or alternatively, the driver warning device 128 may include a speaker that is operable to generate a sound or audible message within the vehicle 110.

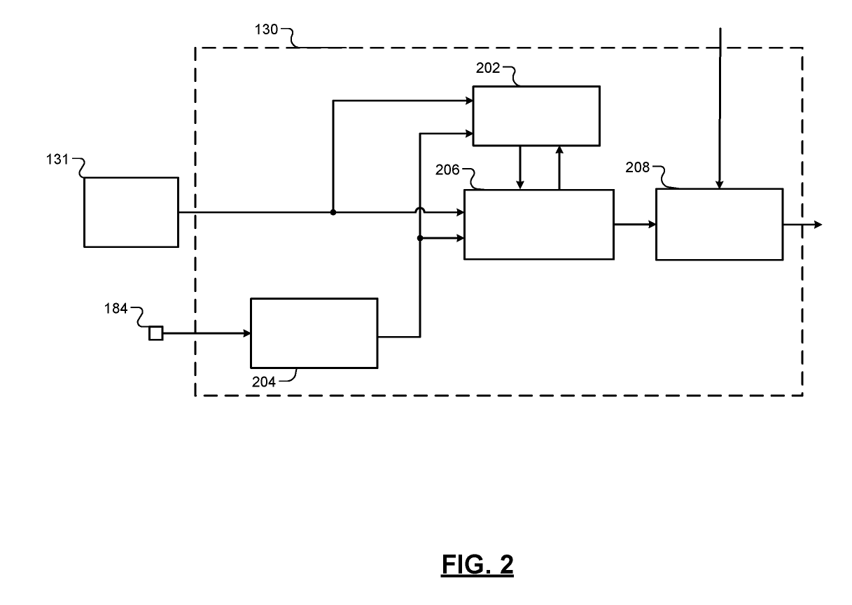

Referring now to FIG. 2, an example implementation of the DCM 130 includes a database 202, a lane curvature determination module 204, a wrong-way determination module 206, and a mitigation module 208. The GPS module 131 provides vehicle position data to the DCM 130. The vehicle position data includes data indicative a current latitude coordinate, a current longitude coordinate, a current heading angle, and/or a current velocity of the vehicle 110. The vehicle position data can be represented as:

. . . p_{g,t-1}(lat,lon,α,v),p_{g,t}(lat,lon,α,v),p_{g,t+1}(lat,lon,α,v), . . . .

where p_{g,t} represents the vehicle position data corresponding the t^{th} vehicle position data element (where t is an integer), lat represents the latitude coordinate of the t^{th} vehicle position data element, lon represents the longitude coordinate of the t^{th} vehicle position data element, α represents the heading angle of the t^{th} vehicle position data element, v represents the velocity of associated with the t^{th} vehicle position data element. The vehicle positional data can be stored as data structure, such as an array, within the database 202.

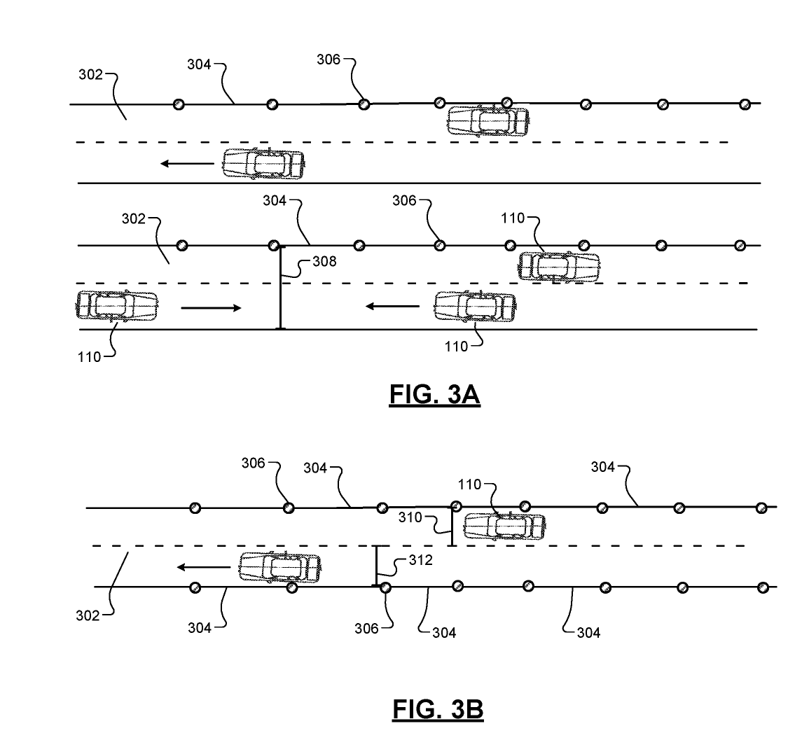

The database 202 stores GPS data received from the GPS module 131, lane curvature data from the lane curvature determination module 204, and roadway data, such as shape point data. Referring to FIGS. 3A and 3B, the shape point data represents the parameters of the roadway 302. The shape point data is associated with one or more roadway markers 304. In an implementation, the roadway markers 304 may be road surface markings, such as paint, thermoplastic, or reflective adhesive. In an implementation, the roadway markers 304 include roadway shoulder boundary markers. One-way travel roadways 302, as shown in FIG. 3A, can include shape points 306 along a single roadway shoulder. Two-way travel roadways, as shown in FIG. 3B, can include shape points 306 along both roadway shoulders.

The shape point data includes a latitude coordinate, a longitude coordinate, a heading angle, a road width, an altitude, and/or lane curvature data of the roadway 302. In an implementation, the database 202 stores the shape point data as an array. For example, the array may include:

. . . ,p_{m,k-1}(lat,lon,α,w,κ),p_{m,k}(lat,lon,α,w,κ),p_{m,k+1}(lat,lon,α,w,κ), . . . .

where p_{m,k} represents the shape point data corresponding the k^{th} shape point data element (where k is an integer), lat represents the latitude coordinate of the k^{th} shape point element, lon represents the longitude coordinate of the k^{th} shape point element, α represents the heading angle of the k^{th} shape point element, w represents the road width associated with the k^{th} shape point element, and κ represents a curvature of the k^{th} shape point element.

In some examples, the roadway width w can represent a width 308 between the shoulders of the roadway 302 as shown in FIG. 3A. In another example, the roadway width w can represent a width 310, 312 between lanes of the roadway 302.

The lane curvature determination module 204 receives data from the forward facing camera 184 and determines a lane curvature of the roadway 302 being traversed. In an implementation, the lane curvature determination module 204 receives image data indicative of the roadway 302 from the forward facing camera 184. The lane curvature determination module 204 classifies the image data as corresponding to the roadway 302, corresponding to roadway markers 304, or the like. For example, the lane curvature determination module 204 uses pixel data to classify portions of the image data as corresponding to the roadway 302 or corresponding to the roadway markers 304.

The lane curvature determination module 204 can use one or more lane curvature approximation techniques to calculate an estimated lane curvature variable using the classified pixel data. For example, the lane curvature determination module 204 can apply suitable line fit approximation techniques to the pixel data representing the roadway markers 304 to estimate the lane curvature variable based upon changes (i.e., curved variations indicating a curve in the roadway 302) in the roadway markers 304 to generate lane curvature variables κₚ_{_{m,k,Cal}} with respect to the direction of travel of the vehicle 110.

The wrong-way determination module 206 receives signals output from the vehicle GPS module 131 and the lane curvature determination module 204. The wrong-way determination module 206 uses these input signals to determine whether the vehicle 110 is traveling in the wrong direction. The wrong-way determination module 206 accesses the database 202 to obtain data elements of interest. For example, the wrong-way determination module 206 requests shape point data corresponding to the current vehicle position data to determine whether the vehicle 110 is traveling in the wrong direction as discussed below.

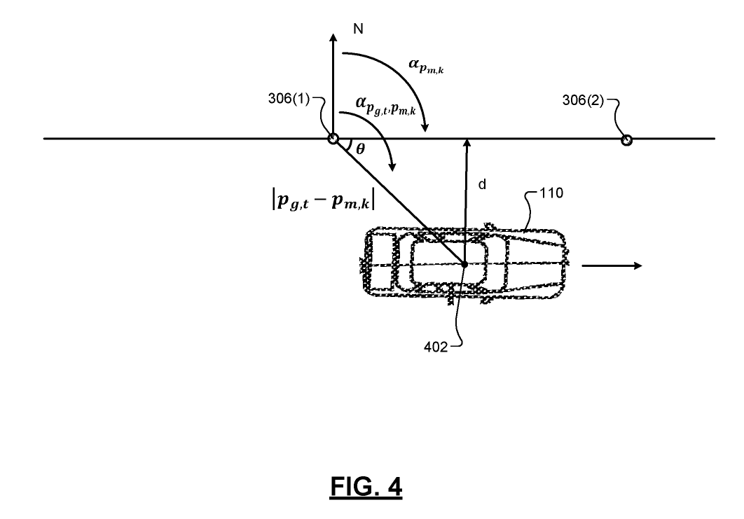

In an implementation, the wrong-way determination module 206 calculates a distance between the current position p_{g,t} and the nearest shape point p_{m,k}. For example, referring to FIG. 4, the wrong-way determination module 206 calculates an orthogonal distance d(p_{g,t}, p_{m,k}) using the current position data element p_{g,t} and the nearest shape point data element p_{m,k} according to:

d(p_{g,t},p_{m,k})=|p_{g,t}−p_{m,k}| sin θ;θ=αₚ_{_{g,t}}_{,p}_{_{m,k}}−αₚ_{_{m,k}}

αₚ_{_{g,t}}_{,p}_{_{m,k}}=arctan((Lat_{g,t}−Lat_{m,k})/(Lon_{g,t}−Lon_{m,k})) EQN. 1

For example, the quantity |p_{g,t}−p_{m,k}| represents a distance between the current position p_{g,t} 402 and the nearest shape point p_{m,k} 306(1) based upon the absolute value of the difference between the coordinates of the current position p_{g,t} 402 and the nearest shape point p_{m,k} 306(1). The variable sine accounts for when the current position p_{g,t} 402 and the nearest shape point p_{m,k} 306(1) are not adjacent to one another. The heading angles associated with the shape point data and the vehicle position data is measured with respect to a common direction, such as North (N). The next shape point p_{m,k+1} is referenced as 306(2).

In another example, the wrong-way determination module 206 calculates a standard distance between the current vehicle positional data element p_{g,t} and the shape point data elements p_{m,k} and p_{m,k+1} according to:

$$d ( {p}_{g , t} , {p}_{m , k} , {p}_{m , k + 1} ) = \frac{\vert ( {lat}_{m , k + 1} - {lat}_{m , k} ) {lon}_{g , t} - ( {lon}_{m , k + 1} - {lon}_{m , k} ) {lat}_{g , t} + {lon}_{m , k + 1} {lat}_{m , k} - {lat}_{m , k + 1} {lon}_{m , k} \vert}{{[ {( {lat}_{m , k + 1} - {lat}_{m , k} )}^{2} + {( {lon}_{m , k + 1} {lon}_{m , k} )}^{2} ]}^{\frac{1}{2}}} , \qquad EQN . 2$$

The variable lat_{m,k+1} represents a latitude coordinate of the roadway at a next shape point. For example, the next shape point may include an adjacent shape point relative to the direction of travel. The variable lat_{m,k} represents a latitude coordinate of the roadway 302 at the current shape point. The variable lon_{g,t} represents a longitude coordinate of the current position of the vehicle 110. The variable lon_{m,k+1} represents a longitude coordinate of the roadway at the next shape point (i.e., next shape point relative to the direction of travel). The variable lon_{m,k} represents a longitude coordinate of the roadway 302 at the current shape point.

To determine whether the vehicle 110 is traveling in the wrong direction, the wrong-way determination module 206 determines whether two conditions are TRUE. For example, the wrong-way determination module 206 compares the calculated distance dₚ_{_{g,t}} to a corresponding roadway width wₚ_{_{m,k}} to determine whether the vehicle 110 is traveling within the boundaries of the roadway 302. The wrong-way determination module 206 also determines whether the absolute value of the difference of the heading angle αₚ_{_{g,t}} of the vehicle 110 and the heading angle αₚ_{_{m,k}} of the shape point 306 is greater than a predetermined threshold.

When traveling in the wrong direction, the heading angles αₚ_{_{g,t}}, αₚ_{_{m,k}} are approximately one hundred and eighty degrees out of phase. In one example, the predetermined threshold can be one hundred and fifty degrees (150°). However, it is understood that other threshold values may be used in accordance with the roadway 302. When both conditions are true, the wrong-way determination module 206 determines the vehicle 110 is traveling in the wrong direction.

If (dₚ_{_{g,t}}<wₚ_{_{m,k}}&&|αₚ_{_{g,t}}−αₚ_{_{m,k}}|>Threshold):

Wrong−Way Driving=TRUE EQN. 3

In some implementations, the wrong-way determination module 206 can determine the vehicle 110 is traveling in the wrong direction using the determine lane curvature variables. The lane curvature variable κₚ_{_{m,k,Cal}} represents a calculated lane curvature relative to the direction of travel of the vehicle 110. The wrong-way determination module 206 compares the calculated lane curvature variables κₚ_{_{m,k,Cal}} with lane curvature variables κₚ_{_{m,k,MAP}} of the roadway 302 to determine if the vehicle 110 is traveling in the wrong direction.

For example, the wrong-way determination module 206 determines the vehicle 110 is traveling in the wrong direction when the absolute value of a sum of a calculated lane curvature data element κₚ_{_{m,k,Cal}} and a corresponding shape point lane curvature data element κₚ_{_{m,k,MAP}} is less than a predetermined low lane curvature threshold and the absolute value of a difference of the calculated lane curvature data element κₚ_{_{m,k,Cal}} and the corresponding shape point lane curvature data element κₚ_{_{m,k,MAP}} is greater than a predetermined high lane curvature threshold, which is shown below:

If (|κₚ_{_{m,k,LS}}+κₚ_{_{m,k,MAP}}|<Low_Threshold&&|κₚ_{_{m,k,LS}}−κₚ_{_{m,k,MAP}}|>High_Threshold):

Wrong−Way Driving=TRUE EQN. 4

The mitigation module 208 receives the wrong-way determination signal from the wrong-way determination module 206. The mitigation module 208 also receives driver input signals indicative of the driver input. The mitigation module 208 generates a mitigation signal when the wrong-way determination module 206 vehicle determines the vehicle 110 is traveling in the wrong direction. The mitigation signal causes the driver warning interface 128 to generate an alert to indicate that the vehicle 110 is traveling in the wrong direction. For example, the alert may be conveyed as a visual alert, an audible alert, a haptic alert, or the like to indicate to the operator that the vehicle 110 is traveling in the wrong direction. The mitigation signal can also cause the driver warning interface 128 to generate external indicators, such as causing the lights to flash, causing the horn to sound, and so on.

The mitigation module 208 can also generate a mitigation signal that controls operation of the vehicle 110. In one example, the mitigation module 208 generates a mitigation signal that causes the brake actuator module 170 to engage the braking components of the vehicle 110. In another example, the mitigation module 208 generates a mitigation signal that causes the steering actuator module 180 to engage the steering components of the vehicle 110 to cause the vehicle to alter trajectory. It is understood that other mitigation techniques may be employed.

In some examples, the mitigation module 208 initiates a time counter upon generating a mitigation signal to generate the alert at the driver warning interface 128. Upon the time counter exceeding a predetermined time and the mitigation module 208 detects no corrective action has occurred based upon driver input, the mitigation module 208 generates the mitigation signal to control operation of the vehicle. Corrective action can include detecting a braking event, a steering event, and the like.

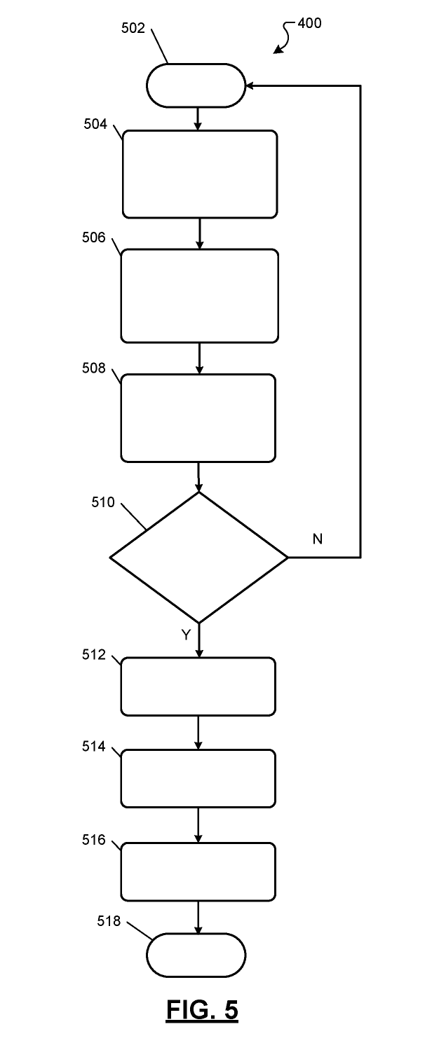

FIG. 5 illustrates an example method 500 for determining whether a vehicle is traveling in a wrong direction along the roadway 302. The method 500 is described in the context of the modules included in the example implementation of the DCM 130 shown in FIG. 2. However, the particular modules that perform the steps of the method may be different than those mentioned below and/or the method may be implemented apart from the modules of FIG. 2.

The method begins at 502. At 504, the GPS module 131 determines the current vehicle positional data. At 406, the lane curvature determination module 204 determines the lane curvature of the roadway 302 being traversed by the vehicle 110. At 408, the wrong-way determination module 206 calculates the distance between the current vehicle position data element p_{g,t} and the shape point data element p_{m,k}.

At 410, the wrong-way determination module 206 determines whether the vehicle 110 is traveling in the wrong direction. For example, the wrong-way determination module 206 determines that the vehicle 110 is traveling in the wrong direction when either Equation 3 OR Equation 4 is TRUE based upon the calculated variables. If both Equation 3 AND Equation 4 are FALSE, the method 400 returns to 402. If either Equation 3 OR Equation 4 is TRUE, the wrong-way determination module 206 determines the vehicle is traveling in the wrong direction.

At 412, the mitigation module 208 causes the driver warning device 128 to generate an alert for the operator of the vehicle 110. At 414, the mitigation module 208 causes the driver warning device 128 to generate an alert for other operators and/or pedestrians. At 416, the mitigation module 208 generates a mitigation signal to control operation of the vehicle 110 via the engine control module 136, the brake actuator module 170, the steering actuator module 180, or the like. At 418, the method 400 ends.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the implementations is described above as having certain features, any one or more of those features described with respect to any implementation of the disclosure can be implemented in and combined with features of any of the other implementations, even if that combination is not explicitly described. In other words, the described implementations are not mutually exclusive, and permutations of one or more implementations with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and microcode, and may refer to programs, routines, functions, classes, data structures, and objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A wrong-way determination system comprising:
a wrong-way determination module that is configured to determine a vehicle is traveling in a wrong direction when a current position of the vehicle with respect to a shape point does not exceed a width of a roadway and a deviation between a heading angle of the vehicle and a heading angle of the roadway exceeds a predetermined threshold; and
a mitigation module that is configured to generate a mitigation signal when the vehicle is traveling in the wrong direction.

2. The wrong-way determination system as recited in claim 1 wherein the roadway includes a roadway marker and the shape point corresponds to the roadway marker.

3. The wrong-way determination system as recited in claim 1 wherein the shape point includes a latitude coordinate, a longitude coordinate, a heading angle, a road width, an altitude, and a roadway lane curvature.

4. The wrong-way determination system as recited in claim 1 wherein the wrong-way determination module determines a distance between the current position and the shape point and compares the distance to the width of the roadway.

5. The wrong-way determination system as recited in claim 4 wherein the wrong-way determination module determines the distance according to |p_{g,t}−p_{m,k}| sin θ; θ=αₚ_{_{g,t}}_{,p}_{_{m,k}}−αₚ_{_{m,k}}, where p_{g,t} represents the current position, p_{m,k} represents a nearest shape point, αₚ_{_{g,t}}_{,p}_{_{m,k}} represents arctan((Lat_{g,t}−Lat_{m,k})/(Lon_{g,t}−Lon_{m,k})), where Lat_{g,t} represents a latitude coordinate of the vehicle at the current position, where Lat_{m,k} represents latitude coordinate of the nearest shape point, where Lon_{g,t} represents a longitude coordinate of the vehicle at the current position, where Lon_{m,k} represents a longitude coordinate of the nearest shape point, and αₚ_{_{m,k}} represents a heading angle of the roadway at the shape point.

6. The wrong-way determination system as recited in claim 4 wherein the wrong-way determination module determines the distance according to
$$\frac{\vert ( {lat}_{m , k + 1} - {lat}_{m , k} ) {lon}_{g , t} - ( {lon}_{m , k + 1} - {lon}_{m , k} ) {lat}_{g , t} + {lon}_{m , k + 1} {lat}_{m , k} - {lat}_{m , k + 1} {lon}_{m , k} \vert}{{[ {( {lat}_{m , k + 1} - {lat}_{m , k} )}^{2} + {( {lon}_{m , k + 1} {lon}_{m , k} )}^{2} ]}^{\frac{1}{2}}} ,$$
where lat_{m,k+1} represents a latitude coordinate of the roadway at a next shape point, lat_{m,k} represents a latitude coordinate of the roadway at the shape point, lon_{g,t} represents a longitude coordinate of the current position, lon_{m,k+1} represents a longitude coordinate of the roadway at the next shape point, lon_{m,k} represents a longitude coordinate of the roadway at the shape point.

7. The wrong-way determination system as recited in claim 1 wherein the mitigation signal causes a driver warning device to notify a driver of the vehicle that the vehicle is traveling in the wrong direction.

8. The wrong-way determination system as recited in claim 7 wherein the driver warning device at least one of displays a notification, generates haptic feedback, generates external feedback, and generates a sound.

9. The wrong-way determination system as recited in claim 1 further comprising a lane curvature determination module that is configured to determine a vehicle lane curvature variable, wherein the wrong-way determination module is further configured to determine the vehicle is traveling in the wrong direction when a deviation between the vehicle lane curvature variable and a roadway lane curvature variable exceeds a predetermined threshold.

10. The wrong-way determination system as recited in claim 9 wherein the wrong-way determination module determines whether the deviation exceeds the predetermined threshold according to (|κₚ_{_{m,k,LS}}+κₚ_{_{m,k,MAP}}|<Low_Threshold && |κₚ_{_{m,k,LS}}−κₚ_{_{m,k,MAP}}|>High_Threshold), where κₚ_{_{m,k,LS}} represents the vehicle lane curvature variable and κₚ_{_{m,k,MAP}} represents the roadway lane curvature variable.

11. The wrong-way determination system as recited in claim 1 wherein the mitigation module initiates a time counter, wherein the mitigation module generates a mitigation signal to control operation of the vehicle when the time counter exceeds a predetermined time and no driver input has been received within the predetermined time.

12. A method comprising:
determining that a vehicle is traveling in a wrong direction when a current position of the vehicle with respect to a shape point does not exceed a width of a roadway and a deviation between a heading angle of the vehicle and a heading angle of the roadway exceeds a predetermined threshold; and
generating a mitigation signal when the vehicle is traveling in the wrong direction.

13. The method as recited in claim 12 wherein the roadway includes a roadway marker and the shape point corresponds to the roadway marker.

14. The method as recited in claim 12 wherein the shape point includes a latitude coordinate, a longitude coordinate, a heading angle, a road width, an altitude, and a roadway lane curvature.

15. The method as recited in claim 12 further comprising determining a distance between the current position and the shape point and compares the distance to the width of the roadway.

16. The method as recited in claim 15 wherein the distance is determined according to |p_{g,t}−p_{m,k}| sin θ; θ=αₚ_{_{g,t}}_{,p}_{_{m,k}}−αₚ_{_{m,k}}, where p_{g,t} represents the current position, p_{m,k} represents a nearest shape point, αₚ_{_{g,t}}_{,p}_{_{m,k}} represents arctan((Lat_{g,t}−Lat_{m,k})/(Lon_{g,t}−Lon_{m,k})), where Lat_{g,t} represents a latitude coordinate of the vehicle at the current position, where Lat_{m,k} represents latitude coordinate of the nearest shape point, where Lon_{g,t} represents a longitude coordinate of the vehicle at the current position, where Lon_{m,k} represents a longitude coordinate of the nearest shape point, and αₚ_{_{m,k}} represents a heading angle of the roadway at the shape point.

17. The method as recited in claim 15 wherein the distance is determined according to
$$\frac{\vert ( {lat}_{m , k + 1} - {lat}_{m , k} ) {lon}_{g , t} - ( {lon}_{m , k + 1} - {lon}_{m , k} ) {lat}_{g , t} + {lon}_{m , k + 1} {lat}_{m , k} - {lat}_{m , k + 1} {lon}_{m , k} \vert}{{[ {( {lat}_{m , k + 1} - {lat}_{m , k} )}^{2} + {( {lon}_{m , k + 1} {lon}_{m , k} )}^{2} ]}^{\frac{1}{2}}} ,$$
where lat_{m,k+1} represents a latitude coordinate of the roadway at a next shape point, lat_{m,k} represents a latitude coordinate of the roadway at the shape point, lon_{g,t} represents a longitude coordinate of the current position, lon_{m,k+1} represents a longitude coordinate of the roadway at the next shape point, lon_{m,k} represents a longitude coordinate of the roadway at the shape point.

18. The method as recited in claim 12 further comprising causing a driver warning device to notify a driver of the vehicle that the vehicle is traveling in the wrong direction based upon the mitigation signal.

19. The method as recited in claim 18 wherein the driver warning device at least one of displays a notification, generates haptic feedback, generates external feedback, and generates a sound.

20. The method as recited in claim 12 further comprising determining a vehicle lane curvature variable; and determining the vehicle is traveling in the wrong direction when a deviation between the vehicle lane curvature variable and a roadway lane curvature variable exceeds a predetermined threshold.
